(19) United States
(12) Patent Application Publication
(10) Pub. No.: US 2003/0172585 A1
(43) Pub. Date: Sep. 18, 2003

(54) Electromagnetic reflective plastic mulch film

(76) Inventor: Gregory Whippo, Lake Zurich, IL (US)

Correspondence Address: Mr. Marc D. Machtinger, Esq., Law Office of Marc D. Machtinger, Ltd., Suite 350, 750 W. Lake Cook Road, Buffalo Grove, IL, 60089-2073, US

(21) Appl. No.: 10/388,054

(22) Filed: Mar. 13, 2003

Related U.S. Application Data
(60) Provisional application No. 60/364,175, filed on Mar. 15, 2002.

(51) Int. Cl. A01G 7/00

(52) U.S. Cl. 47/9

(57) ABSTRACT

A mulch film for enhancing agricultural growth is disclosed. A layer of aluminum is vacuum metallized on a surface of a polymeric film substrate. The substrate is preferably black or white. The substrate is preferably a monolayer or a coextruded layer. In one embodiment, the polymeric film substrate is formed by coextrusion of a high density and a low density polyurethane. The substrate preferably has a thickness of at least 1.0 mil. There are also disclosed embodiments of the invention where stripes or portions of the substrate are intentionally shielded from having a layer of aluminum deposited thereon in various configurations. In yet another embodiment, substantially all of the surface of the substrate is vacuum metallized with a layer of aluminum. In yet another embodiment, the substrate is a transparent polymeric film having a color. Additionally, there is disclosed a method of forming the embodiments of the invention as described above.

### CROSS-REFERENCE TO RELATED APPLICATIONS

This application claims the benefit of U.S. Provisional Application No. 60/364,175, filed Mar. 15, 2002, which is hereby incorporated by reference herein in its entirety.

### TECHNICAL FIELD

The present invention relates to a mulch film for enhancing agricultural growth, and more specifically to a polymeric mulch film having selected surfaces which are vacuum/vapor metallized with a layer of aluminum.

### BACKGROUND OF THE INVENTION

Various mulch films for agricultural use are known and utilized for numerous purposes. Mulch films have been utilized in the agricultural industry to regulate soil temperature and humidity, reduce weed growth, control the amount of solar radiation on the soil, and reduce insect infestation. Conventional mulch films have not optimally achieved these goals in the same mulch film.

Some conventional mulch films have used a clear plastic film. These films may be useful for controlling weed growth and warming underlying soil, but do not significantly enhance plant growth because the film does not adequately reflect radiation back up into the plant system. U.S. Pat. No. 6,189,466, issued to Sinclair et al., discloses a method of controlling the growth of noxious weeds, including the step of using a transparent, infrared radiation retentive, plastic film to heat soil and prevent convective heat loss. However, the film has insufficient reflective qualities useful for repelling or disorienting insect pests, reducing harmful insect population contact with plants, or for reflecting wavelengths useful for plant photosynthesis.

Some conventional mulch films have reflective properties, but these reflective regions do not adequately reflect radiation and do not significantly enhance plant growth. For example, U.S. Pat. No. 4,920,692, issued to Kitamura et al., discloses a mulching laminate film for repelling insect pests. The mulching film is a two-layer laminate film. One layer has a non-vacuum plated reflective film layer having a reflective peak at a wavelength of less than 0.4 micrometer, a reflective spectrum having not less than 1.4 of a ratio (RA/RB) of ultraviolet peak reflectance (RA) and the visible light reflectance at a wavelength of 0.5 micrometer (RB). The second layer is a black film layer containing carbon black. The two-layer design does not adequately reflect radiation because the black film layer is designed to absorb much of the radiation reflected off the reflected layer. Therefore, numerous insect populations continue to grow and wavelengths useful for plant photosynthesis are not significantly directed back up into the plant system.

Other mulch films have sought to improve the reflective qualities of the mulch film to enhance plant growth, but still the results are insufficient. For example, some conventional mulch films use a pigmented or granular plastic film coating to reflect light. U.S. Pat. No. 5,729,929, issued to Burke, discloses a multilayered co-extruded mulch film having one or more strips of reflectively pigmented polymer surrounded by or laid in a wider layer of energy absorbing pigmented polymer. The polymeric material does not adequately reflect radiation back up into the plant system.

Furthermore, conventional films systems have not made the most efficient use of the placement of the reflective region with respect to radiation absorbing regions. For example, the reflective region of the Burke patent is in the center of the plant system where radiation for plant photosynthesis is least likely to be reflected back up into the plant system to enhance plant growth because the plant is physically covering a significant portion of the mulch film. Secondly, since the heat absorbing layer is on the outer portions of the film, the plant region is not heated, but rather is cooled. These films fail to enhance growth for the many plants where growth is enhanced in heated soil regions.

Some conventional mulch designs have attempted to deposit aluminum onto mulch film or laminate aluminum foil to increase the ability of the film to reduce harmful insect pest population contact and enhance plant growth. The problems with these films is the aluminum deposit or foil is easily peeled off, broken off, or oxidized and therefore, the films cannot survive the standard six month growing season.

It would be desirable to provide a mulch film wherein a reflective layer of aluminum is deposited on a polymeric substrate in a configuration where wavelengths, useful for enhancing photosynthesis and the repelling or disorienting of insect pests are optimally positioned to reflect light back up into the plant system and an energy absorption layer is positioned such that the underlying soil may be optimally heated to enhance growth.

### SUMMARY

In view of the insufficiencies discussed above, it is an object of the present invention to provide a mulch film wherein a reflective layer of aluminum is deposited on a polymeric substrate in a configuration where wavelengths, useful for photosynthesis and the repelling or disorienting of insect pests and reducing insect pest contact are positioned to reflect light back up into the plant system and an optional energy absorption layer is positioned such that the underlying soil may be optimally heated to enhance growth.

The invention comprises a mulch film for enhancing agricultural growth such as the cultivation of cash crops. The mulch film has an opaque or non-opaque polymeric film substrate with a layer of aluminum vacuum/vapor metallized on a top surface of the substrate. The substrate is preferably low-density polyethylene, such as LDPE, or LLPDE. The thickness of the substrate can be any suitable thickness, but may be best in the range of 0.48 to 1.3 mils, and preferably is at least 1.0 mils in thickness, ideally 1.3 mils. The substrate is opaque or non-opaque. The substrate may be substantially black, substantially white, blue, red or any other color suitable for selectively absorbing or reflecting radiation from the sun. A black substrate can be used in mulch films for the purpose of eliminating weed growth by blocking most of the ultraviolet and visible radiation necessary for plant growth. Because the black film has absorptive qualities, underlying soil is also heated by the black film. A white substrate has both reflective and absorptive qualities. Preferably, the layer of aluminum on said substrate has an optical density in the range of 1.0 to 2.0.

In one of three heat trap embodiments, aluminum is selectively deposited on the surface of the substrate to enhance plant growth while the non-metallized portion is positioned to selectively control soil temperature. A first and a second embodiment trap heat near the root system of the plant. In a first heat trap embodiment, two vacuum metallized aluminum layers are disposed on a top surface of the substrate. The two metallized layers are separated by an uncoated, non-metallic stripe on the substrate that is substantially centered between the two layers and oriented along a length of the substrate. The uncoated stripe of the substrate is shielded during the vacuum metallization process such that the stripe is non-metallized and is positioned in between the two layers. Preferably, the metallized layers have a width in the range of 8 to 12 inches. The total width of the substrate is preferably in the range of 36 to 84 inches. The underlying substrate may be black, white, red, blue, or any other color suitable for selectively absorbing or reflecting solar radiation.

In a second heat trap embodiment, aluminum is selectively shielded from being deposited on a surface of the substrate during the vacuum metallisation such that aluminum is not deposited on a first and a second stripe. The first stripe and second stripe are spaced apart from each other by a third stripe which comprises the aluminum layer. Each of the first stripe, second stripe, and third stripe run parallel to each other lengthwise. The first stripe and second stripe have, adjacent to their outer edges, portions or stripes which also have a layer of aluminum. Preferably, the first stripe and the second stripe have a width of about 8 inches. The third stripe preferably has a width of 10 inches along a length of the substrate. The mulch film preferably has a width of 36, 48, 54, 60, or 66 inches, or other standard mulch film widths. This embodiment allows planting in both of the non-metallized stripes.

In a third heat trap embodiment, aluminum is vacuum metallized on a top surface of the substrate such that a vacuum metallized aluminum layer is selectively deposited on a top surface of the substrate to form a metallized stripe. The stripe preferably has a width of 36 inches. The stripe 100 is disposed in between two non-metallized portions 110, each portion 110 preferably has a width of 12 inches. In this embodiment, underlying soil is heated on the edges of the mulch film rather than at the center. The underlying substrate may be black, white, red, blue, or any other color suitable for selectively absorbing or reflecting solar radiation.

In yet another embodiment, a layer of aluminum is vacuum metallized on substantially all of a surface of the substrate. The whole surface of this embodiment is reflective and sends back light into the plant system. The substrate must be thick enough to prevent tearing during mechanical application of a roll of this material.

In the above embodiments, the substrate is optionally low-density polyethylene, such as LDPE, LLDPE, or high density polyethylene. The polymeric film can be a monolayer or coextruded layers. In one embodiment, the substrate is formed by coextrusion of a high-density polyethylene and a low-density polyethylene. The top surface is preferably low-density polyethylene to optimize bonding. In each embodiment, the mulch film is preferably substantially free of additives to maximize metal adhesion to the film. However, certain additives, such as UV inhibitors, may be desirable.

In any of the above embodiments, the mulch film is adapted to be rolled into a large roll such that the mulch film can be manually or mechanically laid down in a growing field to cover an area in a row-like fashion. A method of manufacturing the invention as described above is further disclosed.

Other features and advantages of the invention will be apparent from the following detailed description taken in conjunction with the following drawings.

### BRIEF DESCRIPTION OF THE DRAWINGS

FIG. 1 is a top view of a preferred embodiment of the present invention.

FIG. 2 is a top view of another preferred embodiment of the present invention.

FIG. 3 is a top view of yet another preferred embodiment of the present invention.

FIG. 4 is a cross-sectional view of a preferred embodiment of the present invention.

FIG. 5 is a side view of a preferred embodiment of the present invention showing the mulch film being mechanically laid down.

FIG. 6 is a top view of a preferred embodiment of the present invention.

FIG. 7 is a top view of another preferred embodiment of the present invention.

FIG. 8 is a top view of yet another preferred embodiment of the present invention.

FIG. 9 is a cross-sectional view of yet another preferred embodiment of the present invention.

### DETAILED DESCRIPTION

While this invention is susceptible of embodiments in many different forms, there is shown in the drawings and will herein be described in detail preferred embodiments of the invention with the understanding that the present disclosure is to be considered as an exemplification of the principles of the invention and is not intended to limit the broad aspect of the invention to the embodiments illustrated.

The mulch film 10 of the present invention assists vegetable, fruit, plant and agricultural growers in the management and control of damaging insect populations, in the control and management of insect borne virus diseases, and in the control of both fungal and mold development in both vegetable and ornamental plant systems. The invention achieves these objectives by selectively depositing a layer of aluminum 30 on a top surface of a polymer substrate 20. The aluminum layer 30 is capable of reflecting all incoming solar electromagnetic wavelengths, including, but not limited to, radio waves, infrared waves (700-800 nm), visible waves (400-700 nm), ultraviolet waves (280-400 nm), photosynthetic active radiation (PAR) (400-800 nm), from the surface of the mulch film 10 back up into the leaf surface and growing area of plant systems by means of efficient electromagnetic reflection.

Reflected wavelengths such as radio waves and UV wavelengths have been shown to repel and disorient insect order vector virus/disease to vegetable, fruit and ornamental plants. By repelling/disorienting these insects, inhibiting, eliminating and delaying the onset of virus/disease, the mulch film 10 decreases the loss of vegetables, fruit, flowers and increases the marketable yields of such plants, vegetables and fruit. The insect repelling effect of the mulch film 10 also decreases insect feeding on plant and fruits reducing the culling of fruits and plants due to surface defects.

Other reflected wavelengths such as ultra violet and infrared rays also inhibit and delay the formation of fungal/molds that attack these plant systems by drying (infrared/thermal) and sterilizing (ultraviolaet) the lower plant system (leaves and stem) and immediate plant environment (mulch surface). The onset of these fungal/molds is significantly inhibited, reduced and eliminated. Decreasing these fungal/molds significantly reduces the loss of plants both in field plantings and in greenhouse growing.

Other reflected wavelengths (photosynthetic active radiation) initiate growth and sustain plant systems. The mulch film 10 reflects all levels of PAR for an intensive plant growing environment. These rays increase plant leaf density, blossom set, fruit set, and provide for a much healthier plant system.

The aluminum layer 30 also aids growers by reducing the amount of methyl bromide the grower would need to use in fumigating their vegetable beds. Growers in many parts of the United States use methyl bromide applications in the soil under the mulch film to fumigate and kill soil-borne pests, such as nematodes, weeds and fungi in the soil. Unfortunately, as a result, toxic methyl bromide is typically released into the atmospheric air around the plant.

The aluminum layer 30 provides a very effective barrier which will significantly reduce the amount of toxic methyl bromide exhausted into the atmosphere. Typical mulch film substrates, such as LDPE (low-density polyethylene) and high-density polyethylene have open cells. The open cells allow gas and air to permeate through the mulch film. However, these open cells are closed after the mulch film is plated with aluminum. This greatly reduces the amount of toxic methyl bromide that will be exhausted into the atmosphere and reduce the amount of methyl bromide needed by the grower.

The mulch film 10 has an opaque or non-opaque polymeric film substrate 20 with a layer of aluminum 30 vacuum metallized on a top surface of the substrate 20. The substrate 20 is preferably low-density polyethylene, LDPE, or LLPDE, or high density polyethylene. In one embodiment, the substrate 30 is formed by coextrusion of a high-density polyethylene and a low-density polyethylene under a hot process. Optionally, the top surface of the substrate 20 is low-density polyethylene. The thickness of the substrate 20 can be in any suitable range, but my best be in the range of 0.48 to 1.3 mils, and preferably is at least 1.0 mils in thickness, ideally 1.3 mils. However, in the coextruded embodiment, a lesser thickness is possible. The substrate 20 is colored with black, white, red or blue pigmentation/dye to achieve a product which is opaque and will eliminate and/or reduce any light transmission to the soil surface. The aluminized layer 30 reflects as much as 80% to 90% or more of available ultraviolet, infrared, photosynthetic active radiation, and radio waves back up into the plant system when used as a groundcover plastic mulch.

The substrate 20, preferably LLDPE and LDPE, is preferably Corona treated to a DYNE level of between 38-52 DYNE, optimally between 42-52 DYNE, to improve the adhesion of aluminum coating 30 to the LLDPE and LDPE. The adhesion improvement reduces the loss of aluminum coating 30 off the substrate. Moreover, the adhesion improvement allows superior greenhouse and field life of the electromagnetic reflective plastic mulch film such that the film is substantially certain to last the duration of a typical growing season.

For the purposes of maximizing metal adhesion to LLDPE or LDPE films, the common practice of using additives in the production of these films, that might migrate to film surfaces, such as slip agents, anti-block agents, processing aids, antioxidants, surfactants, etc., should be avoided. While these additives are quite functional and harmless in most film applications, they tend to reduce metal adhesion and cause the loss of metal layer in outdoor use.

Aluminum 30 is preferably deposited on the substrate 20 by a vacuum/vapor pressurization process. A roll of the mulch film 10 is mounted in chamber. In the chamber, pressure is reduced by pumping air out of the chamber. The chamber is heated to a temperature where aluminum 30 in the chamber is vaporized and allowed to float upward and bond to the mulch film 10.

Aluminum 30 is deposited on a substantially black, substantially white, red, or blue substrate, or on any colored substrate suitable for selectively absorbing or reflecting solar radiation. A black film substrate 20 is known to be used in mulch films for the purpose of eliminating weed growth by blocking most of the ultraviolet and visible radiation necessary for plant growth. Because the black substrate 20 has absorptive qualities, underlying soil is heated by the black film. The heated soil reaches a temperature wherein weeds and insects in the soil are eliminated or reduced. A white, red or blue substrate 20 eliminates and/or reduces any light transmission to soil surface and also may absorb solar radiation. In yet another embodiment, the substrate 20 is a transparent polymeric film that has a pigment or dye which may be blue, red or any other suitable color. The transparent film allows visible light and short wave infrared light to radiate through.

Preferably, the layer of aluminum 30 on the substrate 20 has an optical density in the range of 1.0 to 2.5 or higher. This degree of optical density is needed to effectively reflect all of the available electromagnetic wavelengths back up into the plant system. The width of the substrate 20 is in any suitable range, but may best be in the range of 0.48 to 1.3 mils or greater, and is preferably 1.3 mils.

The aluminum 30 may selectively be deposited on the substrate such that a heat trap configuration 40 is formed wherein heat is trapped under the mulch film 10, near the root of the plant system, while a substantial amount of all incoming solar electromagnetic wavelengths, including, but not limited to, radio waves, infrared waves, ultraviolet waves, and photosynthetic active radiation (PAR), from the surface of the mulch film is reflected back up into the leaf surface and growing area of plant systems and surrounding area by means of efficient electromagnetic reflection. The reflected wavelengths not only significantly enhance plant growth, but also significantly reduce the number of insect pests in the plant systems by disorienting or confusing them. The insects repelled by the reflected wavelengths include, but are not limited to, aphids, white fly thrips, leafhoppers, cucumber beetles, potato beetles, and spider mites

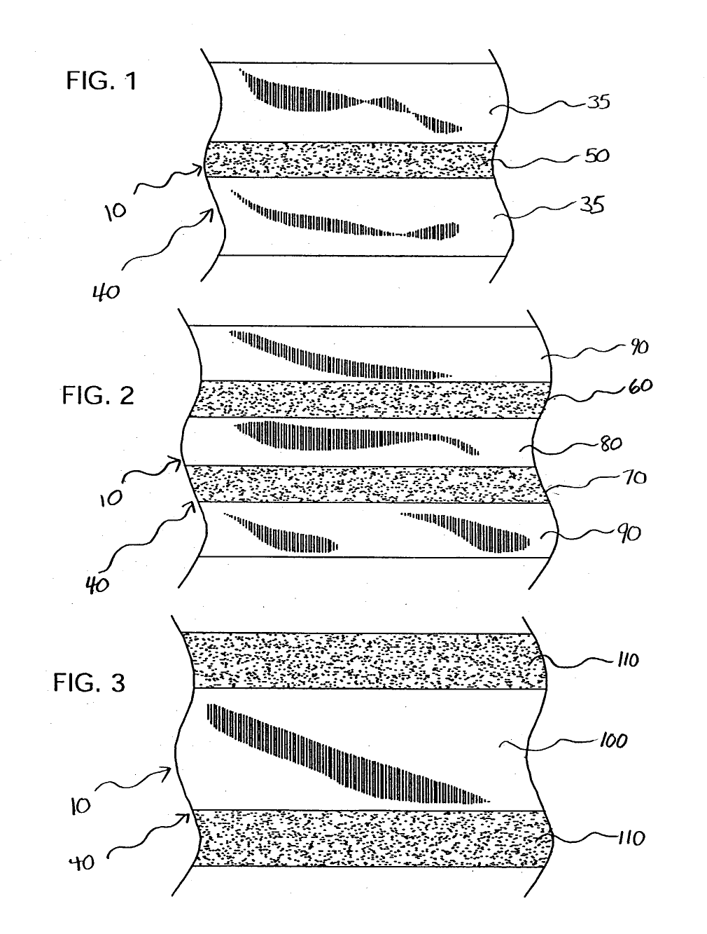

In the invention, there are three heat trap 40 embodiments which selectively deposit aluminum 30 on a surface of the substrate 20 such that the mulch film 10 optimally reflects wavelengths back up into the plant system as discussed and further heat the underlying soil to enhance growth of the plant systems. In a first heat trap 40 embodiment, such as shown in FIG. 1, two vacuum metallized aluminum layers 35 are disposed on a top surface of the substrate. The two metallized layers 35 are separated by an uncoated, non-metallic stripe 50 on the substrate that is substantially centered between the two layers 35 and oriented along a length of the substrate 20. The uncoated stripe 50 of the substrate 20 is shielded during the vacuum metallization process such that the stripe 50 is non-metallized and is positioned in between the two layers 50. A grower will plant his plant(s) in the striped portion of the mulch film. The stripe 50 is effective in conducting thermal energy and in raising the soil temperature in the root zone planting area of vegetable or ornamental plants. The increased soil temperature is effective in enhancing the growth of ornamental plants and yields of cash crops. The two metallized layers 35 reflect substantially all incoming solar electromagnetic wavelengths. Preferably, the stripe 50 has a width in the range of 8 to 12 inches. The total width of the mulch film 10 is preferably in the range of 36 to 84 inches.

In a second heat trap embodiment, such as shown in FIG. 2, a vacuum metallized aluminum layer 30 is selectively disposed on a top surface of the substrate. Aluminum is shielded from being deposited on a first stripe 60 and a second stripe 70. The first stripe 60 and second stripe 70 are spaced apart from each other by a third stripe 80 which comprises the aluminum layer 30. Each of the first stripe 60, second stripe 70, and third stripe 80 run parallel to each other lengthwise. The first stripe 60 and second stripe 70 have, adjacent to their outer edges, portions or stripes 90 which also have a layer of aluminum 30. Preferably, the first stripe 60 and the second stripe 70 have a width of about 8 inches. A grower again will plant his plant(s) in the striped portions 60 and 70 of the mulch film 10. In each of the embodiments, plants 150 are planted through a hole 160 in the mulch film 10 which can be cut by the planter after the mulch film 10 has been set in place. The striped portion is effective in conducting some thermal energy and raising the soil temperature in the root zone planting area of vegetable plants, or any other suitable plant. The aluminized portion 30 again reflects substantially all solar wavelengths back up into the plant system for enhanced plant growth. The first stripe 60 and second stripe 70 are preferably spaced apart by a width of about 10 inches. The mulch film 10 preferably has a width of 60 inches.

In a third heat trap embodiment, such as shown in FIG. 3, aluminum 30 is vacuum metallized on a top surface of the substrate 20 such that a vacuum metallized aluminum layer is selectively deposited on a top surface of the substrate 20 to form a metallized stripe 100. The stripe 100 preferably has a width of 36 inches. The stripe 100 is disposed in between two non-metallized portions 110, each portion 110 preferably has a width of 12 inches. The substrate 20 is substantially white, substantially black, or any other color capable of selectively reflecting or absorbing electromagnetic radiation. This heat trap 40 embodiment differs from the first and second heat trap configurations because in the this heat trap embodiment, the grower plants his plant(s) in the aluminized portion 30 of the mulch film 10 such that light is reflected back up directly under the plant. This heat trap embodiment is useful for plants that are sensitive to the first two heat trap 40 embodiments because soil will be heated at a distance spaced apart from the stem of the plant system.

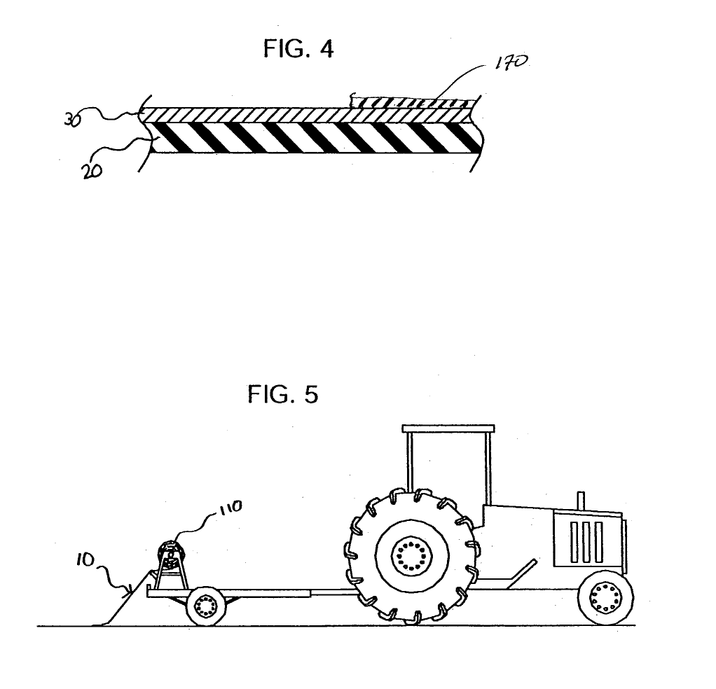

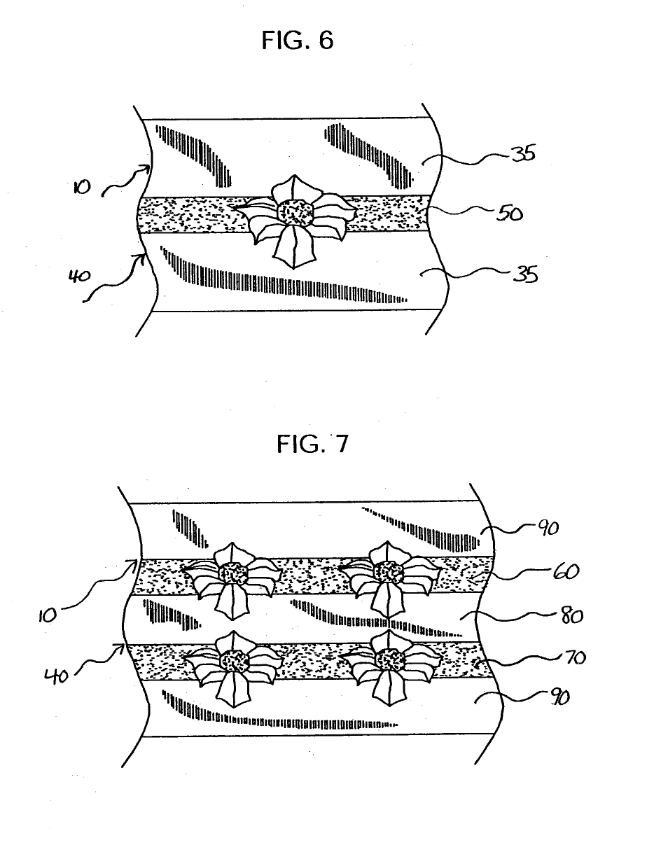

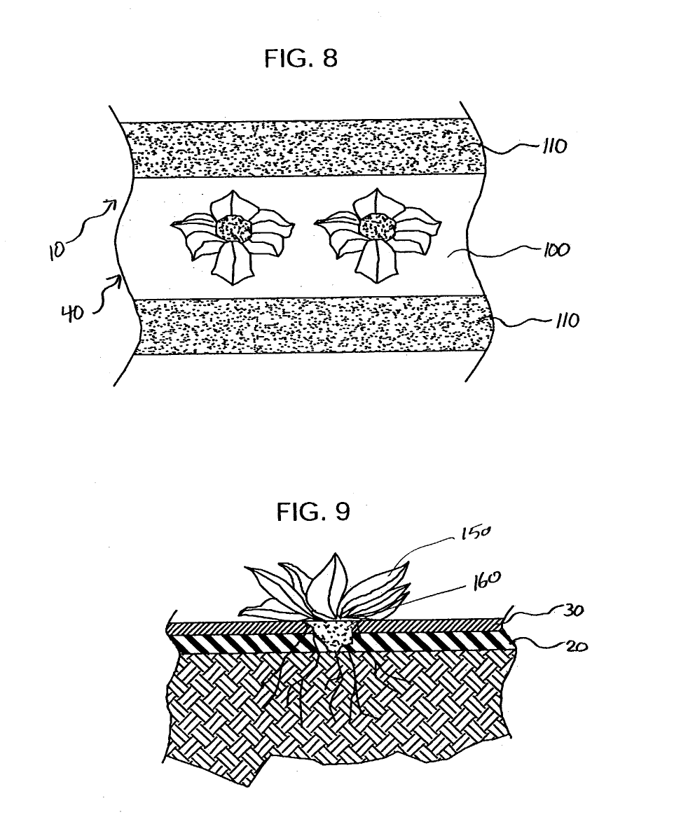

In yet another embodiment, a layer of aluminum 30 is vacuum/vapor metallized on substantially all of a surface of said substrate 20, such as shown in FIG. 4. The whole surface of the mulch film 10 is reflective and sends back light into the plant system.

The mulch film 10 is adapted to be rolled such that the film 10 can be mechanically (see FIG. 5) or manually unrolled to evenly cover an area of land in a row-like manner. Soil anchors down the mulch film 10 on its sides and prevents it from blowing or tearing.

In each of the above embodiments, a clear coating layer 170 can be added to cover the aluminum layer 30 to seal and help reduce, delay, or prevent oxidation and delamination, which can increase the longevity of the film 10. The clear coating 170 can be any suitable coating, including but not limited to a liquid or aqueous clear coating or a clear film coating or lamination. The clear coating 170 is optionally a UV coating. In one preferred embodiment, the clear coating 170 is a printed coating such as flood coating, or roto gravure printing.

A method for manufacturing the mulch film of the present invention is additionally intended within the scope of the invention, as detailed herein.

While the specific embodiments have been illustrated and described, numerous modifications come to mind without significantly departing from the spirit of the invention, and the scope of protection is only limited by the scope of the accompanying claims.

What is claimed is:

1. A mulch film for enhancing agricultural growth, comprising:
a polymeric film substrate having a thickness of at least 1.0 mils, and
a vacuum metallized aluminum layer disposed on a top surface of said substrate.

2. The mulch film according to claim 1, wherein said substrate is low-density polyethylene.

3. The mulch film according to claim 1, wherein said substrate is substantially black in color.

4. The mulch film according to claim 1, wherein said substrate is substantially white in color.

5. The mulch film according to claim 1, wherein the thickness of said substrate is approximately 1.3 mils.

6. The mulch film according to claim 1, wherein the layer of aluminum on said substrate has an optical density in the range of 1.0 to 2.0.

7. The mulch film according to claim 1, wherein said substrate is substantially free of additives for maximizing metal adhesion.

8. The mulch film according to claim 1, wherein the mulch film is adapted to be rolled such that the mulch film can be mechanically unrolled to evenly cover an area of land in a row-like manner.

9. The mulch film according to claim 1, wherein said polymeric film substrate is opaque.

10. The mulch film according to claim 1, wherein said polymeric film substrate is non-opaque.

11. The mulch film according to claim 1, wherein said polymeric film substrate is a color other than black or white.

12. A mulch film for enhancing agricultural growth, comprising:
a polymeric film substrate, and
two vacuum metallized aluminum layers disposed on a top surface of said substrate, wherein said two layers are separated by an uncovered stripe on said substrate substantially centered between said two layers and oriented along a length of said substrate.

13. The mulch film according to claim 12, wherein the width of said stripe is in the range of 8 to 12 inches.

14. The mulch film according to claim 12, wherein, said mulch film has a width of 36 to 84 inches.

15. The mulch film according to claim 12, wherein said substrate is substantially white in color.

16. The mulch film according to claim 12, wherein said substrate is substantially black in color.

17. The mulch film according to claim 12, wherein said polymeric film substrate is opaque.

18. The mulch film according to claim 12, wherein said polymeric film substrate is non-opaque.

19. The mulch film according to claim 12, wherein said polymeric film substrate is a color other than black or white.

20. The mulch film according to claim 12, wherein s aid substrate i s substantially free of additives for maximizing metal adhesion.

21. The mulch film according to claim 12, wherein the mulch film is adapted to be rolled such that the mulch film can be mechanically unrolled to evenly cover an area of land in a row-like manner.

22. A mulch film for enhancing agricultural growth, comprising:
a polymeric film substrate, and
a vacuum metallized aluminum layer comprising a center stripe and two outer stripes on a top surface of said substrate, wherein said substrate comprises a first and a second lengthwise parallel non-metallized stripe spaced apart from each other by siad center stripe, and wherein said first and second stripes are disposed between said outer stripes.

23. The mulch film according to claim 22, wherein said first stripe and said second stripe are of a width of about 8 inches, and wherein said first stripe and said second stripe are spaced apart by a width of about 12 inches.

24. The mulch film according to claim 22, wherein said mulch film has a width of 60 inches.

25. The mulch film according to claim 22, wherein said substrate is substantially black in color.

26. The mulch film according to claim 22, wherein said substrate is substantially white in color.

27. The mulch film according to claim 22, wherein said polymeric film substrate is opaque.

28. The mulch film according to claim 22, wherein said polymeric film substrate is non-opaque.

29. The mulch film according to claim 22, wherein said polymeric film substrate is a color other than black or white.

30. The mulch film according to claim 22, wherein said substrate is substantially free of additives for maximizing metal adhesion.

31. The mulch film according to claim 22, wherein the mulch film is adapted to be rolled such that the mulch film can be mechanically unrolled to evenly cover an area of land in a row-like manner.

32. A mulch film for enhancing agricultural growth, comprising:
a polymeric film substrate, and
a vacuum metallized aluminum layer on a top surface of said substrate, wherein said substrate comprises a metallized stripe disposed in between two non-mettalised portions along a length of said substrate.

33. The mulch film according to claim 32, wherein said metallized stripe has a width of 36 inches.

34. The mulch film according to claim 32, wherein the non-metallized portions have a width of 12 inches.

35. The mulch film according to claim 32, wherein said substrate is substantially black in color.

36. The mulch film according to claim 32, wherein said substrate is substantially white in color.

37. The mulch film according to claim 32, wherein s aid substrate is substantially free of additives for maximizing metal adhesion.

38. The mulch film according to claim 32, wherein the mulch film is adapted to be rolled such that the mulch film can be mechanically unrolled to evenly cover an area of land in a row-like manner.

39. A mulch film for enhancing agricultural growth, comprising:
a polymeric film substrate comprising formed by coextrusion of a high-density polyethylene and a low-density polyethylene, and
a vacuum metallized aluminum layer on a top surface of said substrate

40. The mulch film according to claim 39, wherein said substrate is substantially free of additives for maximizing metal adhesion.

41. The mulch film according to claim 39, wherein the mulch film is adapted to be rolled such that the mulch film can be mechanically unrolled to evenly cover an area of land in a row-like manner.

42. The mulch film according to claim 39, wherein the top surface of said substrate is low-density polyethylene.

43. The mulch film according to claim 39, wherein said polymeric film substrate is opaque.

44. The mulch film according to claim 39, wherein said polymeric film substrate is non-opaque.

45. The mulch film according to claim 39, wherein said polymeric film substrate is a color other than black or white.

46. The mulch film according to claim 39, wherein said polymeric film substrate is substantially black in color.

47. The mulch film according to claim 39, wherein said polymeric film is substantially white in color.

48. A method of manufacturing mulch film for enhancing agricultural growth, comprising:
providing a polymeric film substrate having a thickness of at least 1.0 mils, and
vacuum metallizing an aluminum layer on a top surface of said substrate.

49. The method according to claim 48, wherein said substrate is low-density polyethylene.

50. The method according to claim 48, wherein said substrate is substantially black in color.

51. The method according to claim 48, wherein said substrate is substantially white in color.

52. The method according to claim 48, wherein the thickness of said substrate is 1.3 mils.

53. The method according to claim 48, wherein the layer of aluminum on said substrate has an optical density in the range of 1.0 to 2.0.

54. The method according to claim 48, wherein said substrate is substantially free of additives for maximizing metal adhesion.

55. The method according to claim 48, further comprising rolling said mulch film such that the mulch film can be mechanically unrolled to evenly cover an area of land in a row-like manner.

56. The method according to claim 48, wherein said polymeric film substrate is opaque.

57. The method according to claim 48, wherein said polymeric film substrate is non-opaque.

58. The method according to claim 48, wherein said polymeric film substrate is a color other than black or white.

59. A method of manufacturing mulch film for enhancing agricultural growth, comprising:
providing a polymeric film substrate, and
disposing two vacuum metallized aluminum layers on a top surface of said substrate, and
separating said two layers by an uncovered stripe on said substrate, said stripe substantially centered between said two layers and oriented along a length of said substrate.

60. The method according to claim 59, wherein the width of said stripe is in the range of 8 to 12 inches.

61. The method according to claim 59, wherein said mulch film has a width of 36 to 84 inches.

62. The method according to claim 59, wherein said substrate is substantially white in color.

63. The method according to claim 59, wherein said substrate is substantially black in color.

64. The method according to claim 59, wherein said polymeric film substrate is opaque.

65. The method according to claim 59, wherein said polymeric film substrate is non-opaque.

66. The method according to claim 59, wherein said polymeric film substrate is a color other than black or white.

67. The method according to claim 59, wherein said substrate is substantially free of additives for maximizing metal adhesion.

68. The method according to claim 59, further comprising rolling said mulch film such that the mulch film can be mechanically unrolled to evenly cover an area of land in a row-like manner.

69. A method for manufacturing mulch film for enhancing agricultural growth, comprising:
providing a polymeric film substrate, and
vacuum metallizing an aluminum layer comprising a center stripe and two outer stripes on a top surface of said substrate, and
providing said substrate with a first and a second lengthwise parallel non-metallized stripe spaced apart from each other by said center stripe, and wherein said first and second stripe are disposed between said outer stripes.

70. The method according to claim 69, wherein said first stripe and said second stripe are of a width of about 8 inches, and wherein said first stripe and said second stripe are spaced apart by a width of about 12 inches.

71. The method according to claim 69, wherein said mulch film has a width of 60 inches.

72. The method according to claim 69, wherein said substrate is substantially black in color.

73. The method according to claim 69, wherein said substrate is substantially white in color.

74. The method according to claim 69, wherein said polymeric film substrate is opaque.

75. The method according to claim 69, wherein said polymeric film substrate is non-opaque.

76. The method according to claim 69, wherein said polymeric film substrate is a color other than black or white.

77. The method according to claim 69, wherein said substrate is substantially free of additives for maximizing metal adhesion.

78. The method according to claim 69, further comprising rolling said mulch film such that the mulch film can be mechanically unrolled to evenly cover an area of land in a row-like manner.

79. A method of manufacturing mulch film for enhancing agricultural growth, comprising: mulch film for enhancing agricultural growth, comprising:
providing a polymeric film substrate, and
vacuum metallizing on an aluminum layer on a top surface of said substrate, wherein said substrate comprises a metallized stripe disposed in between two non-mettalized portions along a length of said substrate.

80. The method according to claim 79, wherein said metallized stripe has a width of 36 inches.

81. The method according to claim 79, wherein the non-metallized portions have a width of 12 inches.

82. The method according to claim 79, wherein said substrate is substantially black in color.

83. The method according to claim 79, wherein said substrate is substantially white in color.

84. The method according to claim 79, wherein said substrate is substantially free of additives for maximizing metal adhesion.

85. The method according to claim 79, further comprising rolling said mulch film such that the mulch film can be mechanically unrolled to evenly cover an area of land in a row-like manner.

86. A method of manufacturing mulch film for enhancing agricultural growth, comprising:
forming a polymeric film substrate by coextrusion of a high-density polyethylene and a low-density polyethylene, and
vacuum metallizing an aluminum layer on a top surface of said substrate

87. The method according to claim 86, wherein said substrate is substantially free of additives for maximizing metal adhesion.

88. The method according to claim 86, further comprising rolling said mulch film such that the mulch film can be mechanically unrolled to evenly cover an area of land in a row-like manner.

89. The method according to claim 86, wherein the top surface of said substrate is low-density polyethylene.

90. The method according to claim 86, wherein said polymeric film substrate is opaque.

91. The method according to claim 86, wherein said polymeric film substrate is non-opaque.

92. The method according to claim 86, wherein said polymeric film substrate is a color other than black or white.

93. The method according to claim 86, wherein said polymeric film substrate is substantially black in color.

94. The method according to claim 86, wherein said polymeric film is substantially white in color.

95. The mulch film according to claim 1, further comprising a clear coating disposed on a top surface of said aluminum layer.

96. The mulch film according to claim 12, further comprising a clear coating disposed on a top surface of said aluminum layers.

97. The mulch film according to claim 22, further comprising a clear coating disposed on a top surface of said aluminum layer.

98. The mulch film according to claim 32, further comprising a clear coating disposed on a top surface of said aluminum layer.

99. The mulch film according to claim 39, further comprising a clear coating disposed on a top surface of said aluminum layer.
